(19) United States
(12) Patent Application Publication
(10) Pub. No.: US 2026/0165313 A1
(43) Pub. Date: Jun. 18, 2026

(54) FURNITURE PROTECTOR

(71) Applicant: Phillip Ward Myers, Jr., Wayzata, MN (US)

(72) Inventor: Phillip Ward Myers, Jr., Wayzata, MN (US)

(21) Appl. No.: 19/418,162

(22) Filed: Dec. 12, 2025

Related U.S. Application Data
(60) Provisional application No. 63/733,468, filed on Dec. 13, 2024.

(51) Int. Cl. A01M 29/30; A47C 17/86

(52) U.S. Cl. CPC A01M 29/30; A47C 17/86

(57) ABSTRACT

A furniture protector comprises a first stanchion, a second stanchion, and a strap extending between the first stanchion and the second stanchion. The first stanchion and the second stanchion can removably mount to an article of furniture by sliding between a cushion, arm, and base of a furniture article or between a mattress and base of a furniture article.

### CROSS-REFERENCE TO RELATED APPLICATIONS

This application claims the benefit of priority to U.S. Provisional Patent Application No. 63/733,468, filed Dec. 13, 2024, the contents of which is incorporated by reference herein in its entirety.

### BACKGROUND

Pets kept inside a house sometimes climb onto furniture in the house. This can cause damage thereto.

### SUMMARY

Embodiments disclosed herein can relate to an apparatus for protecting furniture having a first stanchion configured to removably mount to a furniture article, a second stanchion configured to removably mount to a furniture article, and a strap configured to extend between the first stanchion and the second stanchion. In some embodiments, the furniture article is a couch. In some embodiments, the furniture article is a bed. In some embodiments, the first stanchion has a base and a leg, the base configured to wedge between a cushion or mattress of the furniture article and a bottom surface of the furniture article. In some such embodiments, the first stanchion further includes a reel from which the strap extends, and in some such embodiments, the reel includes a ratchet locking mechanism. In some embodiments, the reel can adjustably move up or down relative to the base. In some embodiments, the second stanchion has a base and a leg, the base configured to wedge between a cushion or mattress of the piece of furniture and a bottom surface of the furniture article. In some such embodiments, the second stanchion further includes a locking mechanism configured to removably connect with a distal end of the strap, and in some such embodiments. In some embodiments, the apparatus includes a center stand configured to connect to the strap between the first stanchion and the second stanchion.

Embodiments disclosed herein can relate to a method of protecting furniture including removably mounting a first stanchion on a furniture article, removably mounting a second stanchion on the furniture article, extending a strap from the first stanchion to the second stanchion, and connecting a distal end of the strap to the second stanchion. In some embodiments, the furniture article is a couch. In some embodiments, the furniture article is a bed. In some embodiments, the first stanchion has a base and a leg, the base configured to wedge between a cushion or mattress of the furniture article and a bottom surface of the furniture article. In some such embodiments, the first stanchion further includes a reel from which the strap extends, and in some such embodiments, the reel includes a ratchet locking mechanism. In some embodiments, the reel can adjustably move up or down relative to the base. In some embodiments, the second stanchion has a base and a leg, the base configured to wedge between a cushion or mattress of the piece of furniture and a bottom surface of the furniture article. In some such embodiments, the second stanchion further includes a locking mechanism configured to removably connect with a distal end of the strap, and in some such embodiments. In some embodiments, the apparatus includes a center stand configured to connect to the strap between the first stanchion and the second stanchion. In some embodiments, the method further includes removably mounting a center stand to the furniture article and connecting the strap to the center stand at a position between the first stanchion and the second stanchion.

Embodiments herein can relate to an apparatus for protecting furniture including a first stanchion configured to removably mount to a furniture article, the first stanchion having a leg, a flat base at a bottom end of the leg, and a reel at a top end of the leg, wherein the reel can be adjusted up or down on the leg with respect to the base; a second stanchion configured to removably mount to a furniture article, the second stanchion having a leg, a flat base at a bottom end of the leg, and a locking portion at a top end of the leg, wherein the locking portion can be adjusted up or down on the leg with respect to the base, and a strap, wherein the strap is housed inside the reel and configured to extend from the reel and removably connect to the locking portion.

### BRIEF DESCRIPTION OF THE DRAWINGS

FIG. 1 depicts a furniture protector in accordance with the embodiments disclosed herein.

FIG. 2 depicts a furniture protector in accordance with the embodiments disclosed herein.

FIG. 3 depicts a furniture protector in accordance with the embodiments disclosed herein.

FIG. 4 depicts a furniture protector in accordance with the embodiments disclosed herein.

FIG. 5 depicts a furniture protector in accordance with the embodiments disclosed herein.

FIG. 6 depicts a furniture protector in accordance with the embodiments disclosed herein.

FIG. 7 depicts a furniture protector in accordance with the embodiments disclosed herein.

FIG. 8 depicts a furniture protector in accordance with the embodiments disclosed herein.

FIG. 9 depicts a furniture protector in accordance with the embodiments disclosed herein.

FIG. 10 depicts a furniture protector in accordance with the embodiments disclosed herein.

FIG. 11 depicts a furniture protector in accordance with the embodiments disclosed herein.

FIG. 12 depicts a furniture protector in accordance with the embodiments disclosed herein.

### DESCRIPTION

Some people keep pets, such as cats or dogs, inside their house. In most houses where pets are kept, there is also furniture for use by humans. In many cases, pets kept inside a house with furniture want to interact with the furniture, such as by jumping or crawling on the furniture, laying on the furniture, or scratching the furniture. Because a pet's interacting with furniture can cause damage to the furniture or cause pet hair and odors to appear on the furniture, people sometimes want to prevent an animal from interacting with the furniture.

Embodiments herein relate to furniture protectors that can restrict or prevent ingress or egress of furniture by an animal, such as domesticated pets such as dogs. The furniture can be a couch, chair, bed or other furniture. The furniture protectors disclosed herein can be removably mounted to furniture. The furniture protectors disclosed herein can be mounted to furniture without requiring any permanent modifications to the furniture. In other words, the furniture protectors disclosed herein do not require anything to be glued, taped, screwed, bolted, or otherwise fixed to the furniture in a way that alters the furniture. The furniture protectors disclosed herein can be mounted to furniture simply by sliding it underneath a cushion, for example. The furniture protectors disclosed herein are adaptable and can be mounted to furniture having different dimensions and/or configurations without requiring any modifications to the furniture protector.

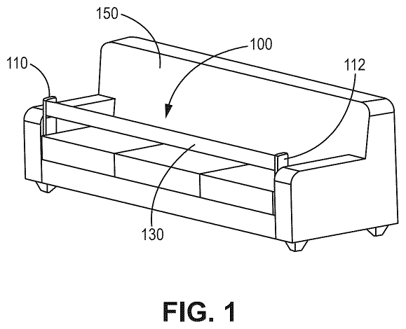

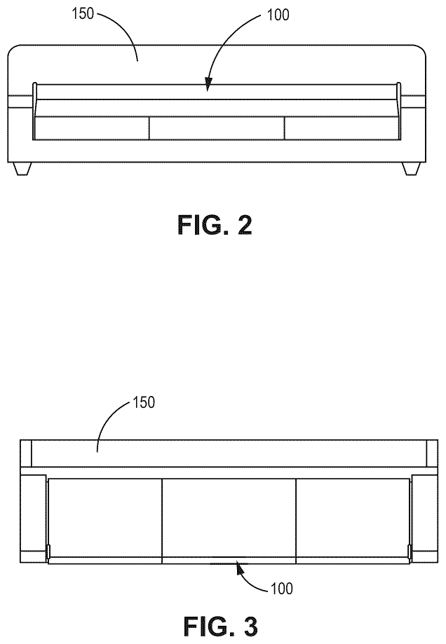

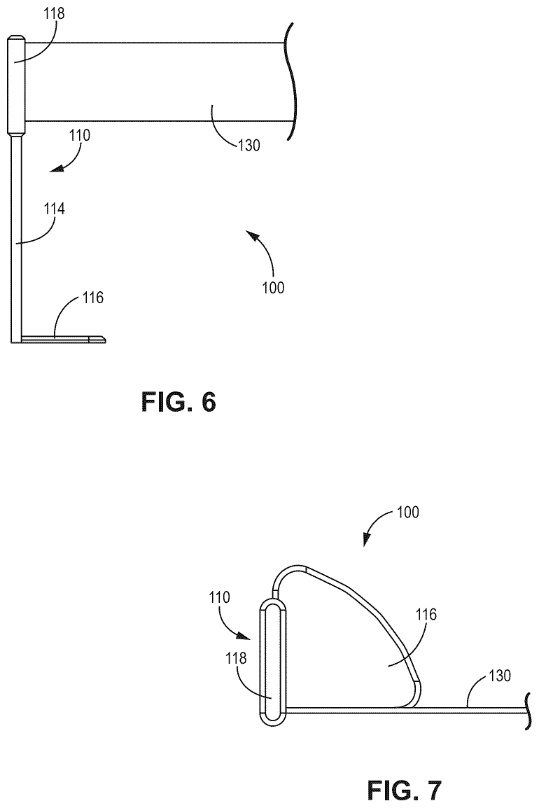

FIGS. 1-8 depict a furniture protector 100 in accordance with the various embodiments herein. FIGS. 1-3 show the furniture protector 100 in use on a couch 150. FIG. 1 shows a perspective view, FIG. 2 shows a front view, and FIG. 3 shows a top view of the furniture protector 100 in use on the couch 150. The furniture protector 100 has a proximal stanchion 110, a distal stanchion 112, and a strap 130 spanning the gap between the proximal stanchion 110 and the distal stanchion 112. The proximal stanchion 110 is positioned on a first side of the couch 150 (e.g., right side) and the distal stanchion 150 is positioned towards a second side of the couch 150 (e.g., left side). The strap 130 therefore spans the front of the couch from the first side of the couch 150 to the second side of the couch 150. In this way, the strap 130 provides a barrier on the front of the couch that prevents an animal from climbing onto the couch and/or interacting with the portions of the couch where humans sit (e.g., cushions, arms, back, etc.). In this embodiment, the strap 130 is retractable, and can be retracted and extended into and out of the proximal stanchion 110 and clipped onto the distal stanchion 112. In the example shown in these figures, the proximal stanchion 110 is configured to mount to the right side of a couch or other piece of furniture (from the perspective of a person sitting thereon) and the distal stanchion 112 is configured to mount to the left side of the piece of furniture, but this is exemplary only. It is contemplated that the proximal stanchion 110 could be configured to go on the left side of a piece of furniture and the distal stanchion 112 could be configured to mount to the right side of a piece of furniture. In some embodiments, the apparatus is configured to prevent animals from climbing onto and/or interacting with a bed. In such embodiments, the proximal stanchion 110 or distal stanchion 112 could be configured to mount to a bed, including any corner thereof.

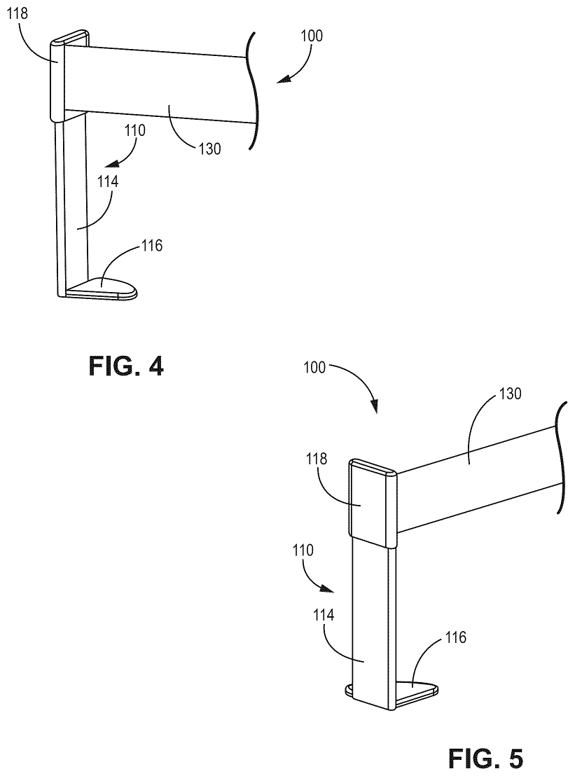

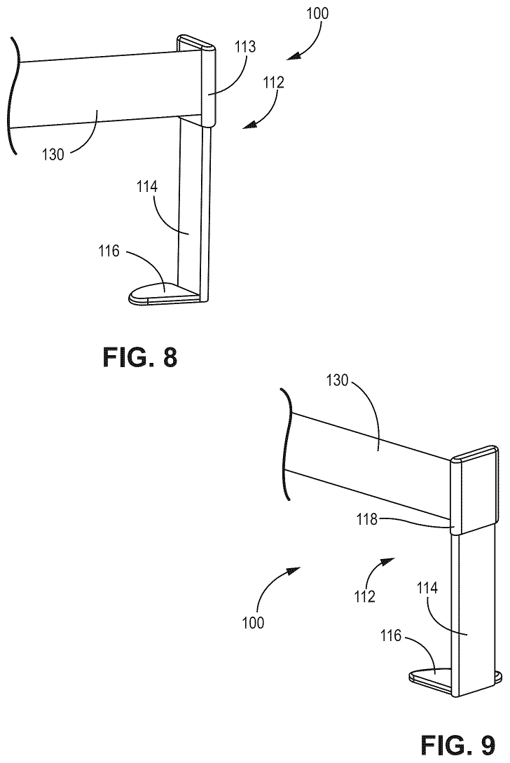

FIGS. 4-9 show the furniture protector 100 in greater detail. FIGS. 4-7 show the proximal stanchion 110 in greater detail and FIGS. 8-9 show the distal stanchion 112 in greater detail. The proximal stanchion 110 comprises a leg 114, a base 116, and a reel 118. The strap 130 can extend from or retract into the reel 118. The strap 130 can extend from the reel 118 of the proximal stanchion 110 to a locking portion 113 of the distal stanchion 112, which can be as a rail, clip, or other locking structure for retaining a distal end of the strap 130.

The reel 118 can have a bias mechanism, such as springs, that provide a retracting force on the strap 130 so that it is under tension when spanning the couch 150 from the proximal stanchion 110 to the distal stanchion 112, and also so that the strap 130 will retract into the reel 118 when released from the distal stanchion 112. The reel can also be configured as a ratcheting reel or locking retractable reel, so that the strap 130 can be pulled out to a position and locked into place without the retracting bias force being applied to it. In such embodiments, the strap 130 can be unlocked by pulling it out from the reel 118 slightly so that the bias force is applied to the strap 130 to retract it.

The reel 118 can be fixed into position or can be movably mounted to the leg 114 such that it can be adjusted up or down to a desired height with respect to the base 116. The corresponding locking structure 113 on the distal stanchion 112 on which the distal end of the strap 130 is fixed can also be adjusted up or down with respect to the base 116 of the distal stanchion 112.

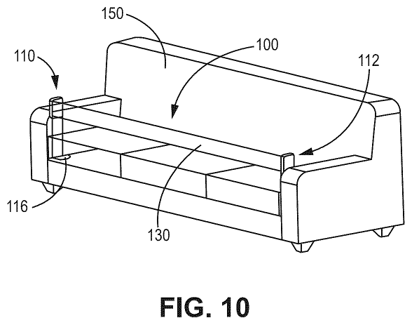

The base 116 of each stanchion is configured to tuck underneath a portion of an article of furniture, such as underneath a cushion of a couch 150 or underneath the mattress of a bed. FIG. 10 shows the couch protector 100 installed on the couch 150 with a cushion 152 shown as a transparent line drawing so that the otherwise obscured portions of the base 116 and leg 114 of the proximal stanchion 110 can be seen. The base 116 and leg 114 of the proximal stanchion are held into position on the front and side of the couch 150 by the cushion 152. In other words, the proximal stanchion 110 is wedged between a bottom surface of the couch 150, a side (i.e., arm) of the couch 150, and the cushion 152. The distal stanchion 112 is held into position in the same way on the other side of the couch 150.

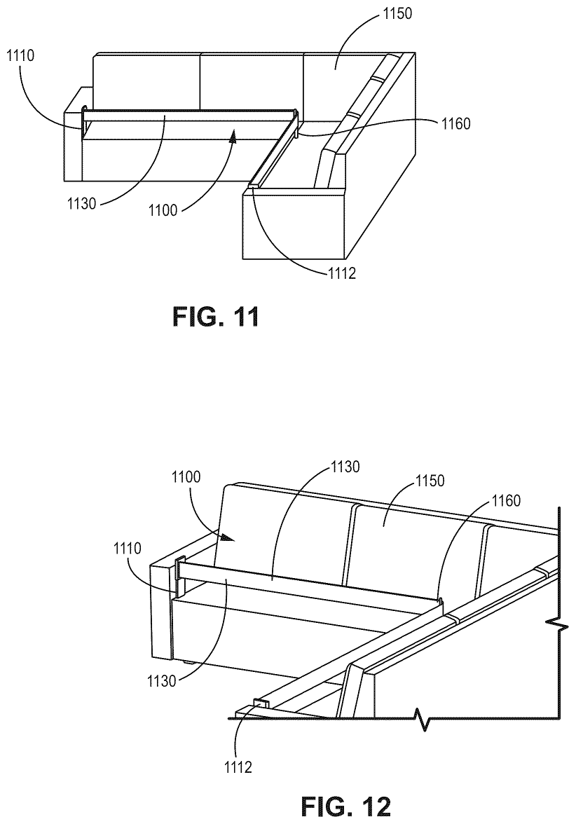

In some embodiments, a furniture protector includes an additional component enabling it to span a distance that includes two or more linear portions at an angle with respect to each other. As an example, the furniture protector 1100 depicted in FIGS. 11 and 12 can create a barrier on an L-shaped couch 1150. The furniture protector 1100 has a proximal stanchion 1110, distal stanchion 1112, and strap 1130 that are all consistent with the respective elements described herein with respect to the furniture protector 100. The furniture protector 1100 further includes a center post 1160 for allowing the strap 1130 to block two linear segments that are at an angle with respect to each other, i.e. the two front portions of the L-shaped couch 1150.

The center post 1160 can have a leg and a base that allow it to be wedged between one or more cushions and the base of the couch 1150. The center post 1160 can also have a structure, such as a slot or hook, for holding up the strap 116 that bends around a portion of the center post. In some other embodiments, the furniture protector 1100 comprises two straps: a first strap extending between the proximal stanchion to the center post 1160 and a second strap extending between the distal stanchion to the center post 1160. In such embodiments, any of the proximal stanchion 1110, the distal stanchion 1112, and the center post 1160 can have one or more reels from which a strap 1160 can retractably extend and one or more locking structures onto which a distal end of a strap 1160 can be removably fixed. In this way, both stanchions can have reels from which separate straps extend to be fixed to the center post, the center post can have one or more reels from which separate straps extend to be fixed to the stanchions, or any combination thereof. The embodiments shown herein are exemplary and not meant to be limiting.

In some embodiments, a furniture protector apparatus is suited specifically for protecting beds. In some such embodiments, four stanchions generally consistent with those described herein are configured specifically for mounting to a bed by tucking underneath a mattress. In other words, the bases can have a flat shape for being positioned between a mattress and a box spring or other bed base, and the legs of each stanchion can be positioned on the base to allow for the base to be so positioned underneath a mattress at the corners of a bed. When set up for protecting a bed, the four stanchions can be positioned in each corner of the bed, with any number of straps running from stanchion-to-stanchion. In some embodiments, at least three of the four stanchions comprise a reel from which a strap can extend so that: a strap runs between a stanchion at the left/head corner to a stanchion at the left/foot corner; a strap runs between a stanchion at the right/head corner to a stanchion at the right/foot corner; and a strap runs between the left/foot corner and the right/foot corner. In some embodiments, a strap additionally runs between a stanchion at the left/head corner and a stanchion at the right/head corner. Any stanchion can include a reel and/or locking mechanism such that a strap can extend from any stanchion, the distal end of which can connect to any other stanchion. In some embodiments, a stanchion comprises both a reel and a locking mechanism so that it can both receive and provide a strap.

Methods of protecting furniture can be performed using the apparatuses disclosed herein. Such a method can including removably mounting a first stanchion on a furniture article, removably mounting a second stanchion on the furniture article, extending a strap from the first stanchion to the second stanchion, and connecting a distal end of the strap to the second stanchion. In some embodiments, the furniture article is a couch. In some embodiments, the furniture article is a bed. In some embodiments, the method further includes removably mounting a center stand to the furniture article and connecting the strap to the center stand at a position between the first stanchion and the second stanchion.

The materials used to construct the components of the furniture protectors are not limited. In some embodiments, the stanchions and/or center posts are made of plastic, such as ABS and the like. The stanchions can also comprise other materials such as metals, woods, composite materials, ceramics, or any other suitable materials. In some embodiments, the straps comprise vinyl. The straps can also comprise other materials such as any fabrics, synthetic materials, and the like. The straps can also be configured as ropes, chains, cables, or any other flexible structure capable of retracting into a reel and spanning a distance between stanchions and/or center posts.

What is claimed:

1. An apparatus for protecting furniture comprising:
a first stanchion configured to removably mount to a furniture article;
a second stanchion configured to removably mount to a furniture article; and
a strap configured to extend between the first stanchion and the second stanchion.

2. The apparatus of claim 1, wherein the furniture article is a couch.

3. The apparatus of claim 1, wherein the furniture article is a bed.

4. The apparatus of claim 1, wherein first stanchion comprises a base and a leg, the base configured to wedge between a cushion or mattress of the furniture article and a bottom surface of the furniture article.

5. The apparatus of claim 4, wherein the first stanchion further comprises a reel from which the strap extends.

6. The apparatus of claim 5, wherein the reel comprises a ratchet locking mechanism.

7. The apparatus of claim 5, wherein the reel can adjustably move up or down relative to the base.

8. The apparatus of claim 1, wherein second stanchion comprises a base and a leg, the base configured to wedge between a cushion or mattress of the piece of furniture and a bottom surface of the furniture article.

9. The apparatus of claim 8, wherein the second stanchion further comprises a locking mechanism configured to removably connect with a distal end of the strap.

10. The apparatus of claim 1, further comprising a center stand configured to connect to the strap between the first stanchion and the second stanchion.

11. A method of protecting furniture comprising:
removably mounting a first stanchion on a furniture article;
removably mounting a second stanchion on the furniture article;
extending a strap from the first stanchion to the second stanchion; and
connecting a distal end of the strap to the second stanchion.

12. The method of claim 11, wherein the furniture article is a couch.

13. The method of claim 11, wherein the furniture article is a bed.

14. The method of claim 11, wherein first stanchion comprises a base and a leg, the base configured to wedge between a cushion or mattress of the furniture article and a bottom surface of the furniture article.

15. The method of claim 12, wherein the first stanchion further comprises a reel from which the strap extends.

16. The method of claim 15, wherein the reel comprises a ratchet locking mechanism.

17. The method of claim 15, wherein the reel can adjustably move up or down relative to the base.

18. The method of claim 11, wherein the second stanchion comprises a base and a leg, the base configured to wedge between a cushion or mattress of the piece of furniture and a bottom surface of the furniture article.

19. The method of claim 18, wherein the second stanchion further comprises a locking mechanism configured to removably connect with a distal end of the strap.

20. The method of claim 19, wherein the locking mechanism can adjustably move up or down relative to the base.

21. The method of claim 11, further comprising removably mounting a center stand to the furniture article and connecting the strap to the center stand at a position between the first stanchion and the second stanchion.

22. An apparatus for protecting furniture comprising:
a first stanchion configured to removably mount to a furniture article, the first stanchion comprising:
a leg;
a flat base at a bottom end of the leg; and
a reel at a top end of the leg, wherein the reel can be adjusted up or down on the leg with respect to the base;
a second stanchion configured to removably mount to a furniture article, the second stanchion comprising:
a leg;
a flat base at a bottom end of the leg; and
a locking portion at a top end of the leg, wherein the locking portion can be adjusted up or down on the leg with respect to the base; and
a strap, wherein the strap is housed inside the reel and configured to extend from the reel and removably connect to the locking portion.
